(19) United States
(12) Patent Application Publication
(10) Pub. No.: US 2017/0324373 A1
(43) Pub. Date: Nov. 9, 2017

(54) PHOTOVOLTAIC COLLECTOR

(71) Applicant: SOLAR MOBILITY, LLC, Windsor, CO (US)

(72) Inventors: Donald Y. Shanfelt, Windsor, CO (US); David R. King, Littleton, CO (US)

(21) Appl. No.: 15/484,363

(22) Filed: Apr. 11, 2017

Related U.S. Application Data
(60) Provisional application No. 62/333,365, filed on May 9, 2016.

(51) Int. Cl. H02S 40/44; H02S 10/40; H02S 30/20; H02J 7/35

(52) U.S. Cl. CPC H02S 40/44; H02J 7/35; H02S 10/40; H02S 30/20

(57) ABSTRACT

Disclosed is an inflatable solar photovoltaic collector system that uses a flexible tubular plastic enclosure that is inflated to support a solar photovoltaic collector. Both the flexible tubular plastic enclosure and the solar photovoltaic collector can be flexible and lightweight and can be used as a portable generator of electricity. In addition to providing support for the solar photovoltaic collector, the flexible tubular plastic enclosure can also be inflated with a blower, which cools the solar photovoltaic collector to prevent thermal radiation damage to the solar photovoltaic collector and simultaneously provides a source of warm air. Further, the flexible tubular plastic enclosure can be inflated with a lighter-than-air gas so that the inflatable photovoltaic collector system floats in air. Also, the flexible tubular plastic enclosure can be tightly sealed so that the inflatable photovoltaic collector system floats in water. The system can also be used to create a source of potable water.

### BACKGROUND

Solar energy has become an important source of alternative energy. There are many advantages associated with the generation of electrical power from solar photovoltaic collectors. Solar photovoltaic collectors allow electrical energy to be generated off grid, which is beneficial when electrical power is not available.

### SUMMARY

An embodiment of the present invention may therefore comprise a method of generating electrical power and warm air from the sun comprising: placing a flexible solar photovoltaic collector in a flexible tubular plastic enclosure so that the flexible solar photovoltaic collector is supported by the flexible tubular plastic enclosure; inflating the flexible tubular plastic enclosure so that the flexible solar photovoltaic collector is supported by the flexible tubular plastic enclosure; moving the flexible tubular plastic enclosure so that the flexible solar photovoltaic collector is directed at the sun; collecting electrical energy obtained by the flexible solar photovoltaic collector with a pair of wires; connecting the wires to a battery; storing the electrical energy in a battery.

An embodiment of the present invention may further comprise a solar energy system comprising: a flexible solar photovoltaic collector having a predetermined height and a predetermined length; a flexible tubular plastic enclosure surrounding the flexible solar photovoltaic collector, the flexible tubular plastic enclosure having a diameter that substantially matches the height of the flexible tubular plastic enclosure and a length that is greater than the predetermined length of the flexible solar photovoltaic collector, the flexible tubular plastic enclosure inflated so that the flexible solar photovoltaic collector is supported in the flexible tubular plastic enclosure and the flexible tubular plastic enclosure and the flexible solar photovoltaic collector can be pointed towards sunlight by moving the flexible tubular plastic enclosure; wires connected to the flexible solar photovoltaic collector for collecting electrical energy from the flexible solar photovoltaic collector; a battery connected to the flexible solar photovoltaic collector by wires for storing the electric energy.

### BRIEF DESCRIPTION OF THE DRAWINGS

FIG. 1 is a perspective view of one embodiment of a static inflatable photovoltaic collector system 100.

FIG. 2 is a sectional side view of an embodiment of the static inflatable photovoltaic collector system 100 of FIG. 1 wherein the solar photovoltaic collector 102 remains approximately flat within flexible tubular plastic enclosure 104.

FIG. 3 is sectional side view of an embodiment of the static inflatable photovoltaic collector system 100 of FIG. 1 wherein the flexible tubular plastic enclosure 104 comprises a first chamber 107, a second chamber 108, and a third chamber 109, and the photovoltaic cell is disposed within the third chamber 109.

FIG. 4 is a sectional side view of an embodiment the of static inflatable photovoltaic collector system 100 of FIG. 1 wherein a flexible solar photovoltaic collector 102 takes a parabolic shape within flexible tubular plastic enclosure 104.

FIG. 5 is a perspective view of the embodiment of FIG. 1 configured vertically for mounting on, for example, a vertical wall.

FIG. 6 is a perspective view of the embodiment of FIG. 1 configured horizontally and floated on a body of water.

FIG. 7 is a perspective view of another embodiment comprising two solar photovoltaic collectors 100.

FIG. 8 is another embodiment showing the addition of a retention flange and a retention stake to both anchor the assembly to the ground and to orient it toward the sun.

FIG. 9 is a perspective view of the embodiment of FIG. 8.

FIG. 10 is a schematic of one embodiment for using a photovoltaic collector.

FIG. 11 is a perspective view of another embodiment of a photovoltaic collector.

FIG. 12 is a partial perspective view of another embodiment of a self-erecting inflatable solar heat and photovoltaic collector.

FIG. 13 is a sectional side view of the embodiment of FIG. 12.

FIG. 14 is a sectional side view of another embodiment of the self-erecting inflatable solar heat and photovoltaic collector.

FIG. 15 is perspective view of another embodiment of the self-erecting inflatable solar heat and photovoltaic collector having a retention flange, retention stakes and a warm air exhaust duct.

FIG. 16 is a sectional side view of another embodiment of a self-erecting inflatable solar photovoltaic collector and water distiller.

### DETAILED DESCRIPTION OF THE EMBODIMENTS

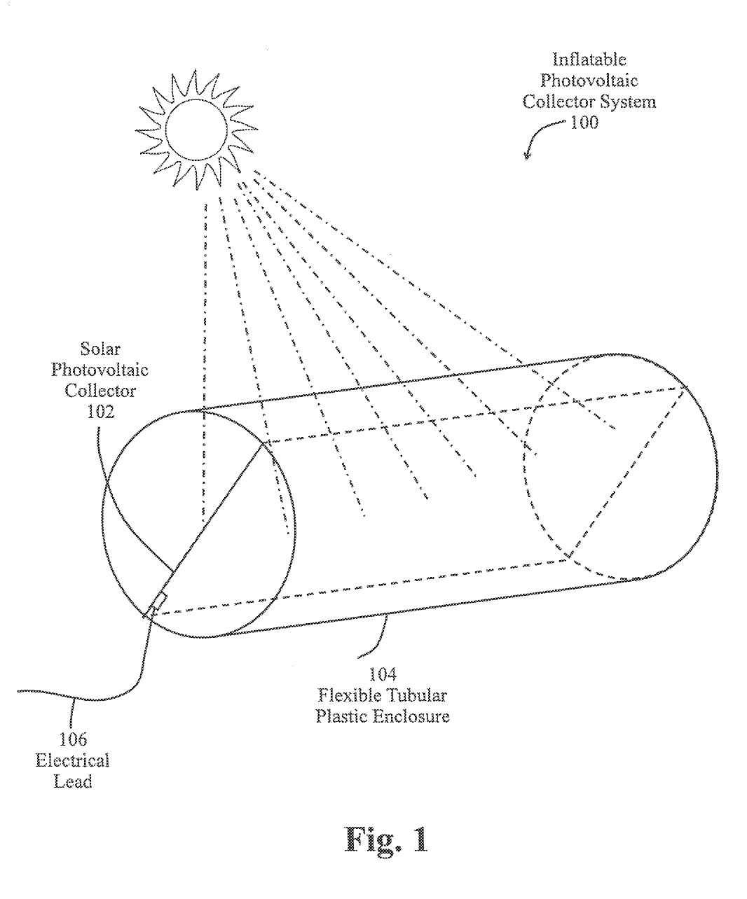

FIG. 1 is perspective view of one embodiment of a static inflatable photovoltaic collector system 100. Solar photovoltaic collector 102 is disposed within flexible tubular plastic enclosure 104, which can be transparent. Flexible tubular plastic enclosure 104 is then inflated with air via a valve, forming a support for solar photovoltaic collector 102. Electrical lead 106 extends through a sealed opening in flexible tubular plastic enclosure 104. Flexible tubular plastic enclosure 104 is made from a transparent plastic material such as polyethylene film, although other transparent and flexible materials, such a polyvinylchloride could be used. When made from, for example, polyethylene film, flexible tubular plastic enclosure 104 is easily repaired with a clear adhesive tape, or can be inexpensively replaced. In certain embodiments, flexible tubular plastic enclosure 104 is lightweight, collapsible and readily packable into, for example, a backpack. Flexible tubular plastic enclosure 104 provides a simple, inexpensive, and portable support for solar photovoltaic collector 102.

Solar photovoltaic collector 102, illustrated in FIG. 1, can be any lightweight photovoltaic panel. In particular embodiments, solar photovoltaic collector 102 is a flexible, packable photovoltaic panel and may also be weather-proof. These types of photovoltaic cells comprise an amorphous film, such as cadmium telluride, that is deposited on a flexible plastic substrate. Any desired type of plastic flexible substrate can be used. The solar photovoltaic collector material is then covered with a coating or film for protection. The use of a flexible plastic substrate allows the solar photovoltaic collectors to be rolled up and easily packaged for portability. Many flexible, weather-proof solar photovoltaic panels are currently available in a range of power ratings (e.g., 7 watt, 13, watt, 14 watt, 21 watt, 28 watt, 100 watt). Given the characteristics of solar photovoltaic collector 102 and flexible tubular plastic enclosure 104, static inflatable photovoltaic collector system 100 is particularly well suited as a portable solar power source for backpacking, camping, RVing, boating, and other outdoor activities. The rated power output of solar photovoltaic collector 102 can be selected to meet the needs of the intended application.

In another embodiment, static inflatable photovoltaic collector system 100 is inflated with a gas that is lighter than air, such as helium, and used for tethered or non-tethered flight. Such an embodiment can be used for aerial displays or signs, or attached to a “self-powered” drone.

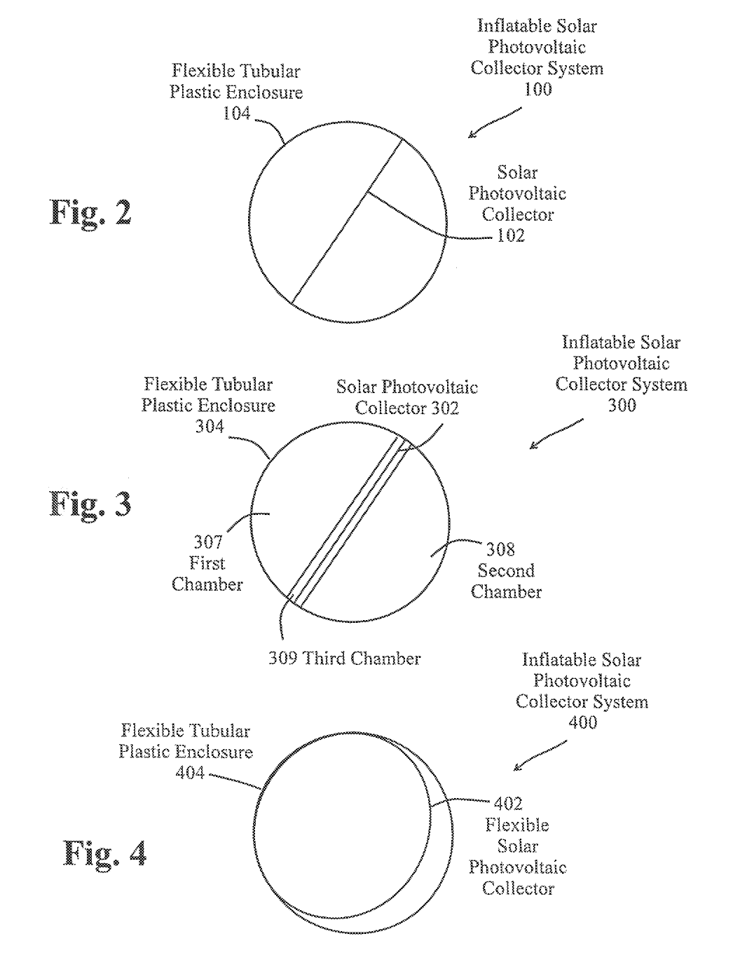

FIG. 2 is a sectional side view of another embodiment of the static inflatable photovoltaic collector system 100 of FIG. 1. The diameter of flexible tubular plastic enclosure 104 is such that solar photovoltaic collector 102 remains approximately flat within the fully inflated flexible tubular plastic enclosure 104. As shown in FIG. 2, the height of the solar photovoltaic collector 102 is substantially the same size as the diameter of the flexible tubular plastic enclosure 104. The solar photovoltaic collector 102 can have a height that varies slightly from the diameter of the flexible tubular plastic enclosure 104 and can be slightly less than or slightly greater than the diameter. Of course, the flexible tubular plastic enclosure 104 can accommodate various heights of the solar photovoltaic collector 102 and still provide support for the solar photovoltaic collector 102. As long as support is provided by the flexible tubular plastic enclosure 104 for the solar photovoltaic collector 102, the height of the solar photovoltaic collector 102 is considered to be substantially the same as the diameter of the flexible tubular plastic enclosure 104.

FIG. 3 is a sectional side view of another embodiment of a static inflatable photovoltaic collector system 300, wherein the flexible tubular plastic enclosure 304 comprises a first chamber 307, a second chamber 308, and a third chamber 309, and the solar photovoltaic collector 302 is disposed within the third chamber 309. The three chambers can be formed in a number of ways, including but not limited to sealing two flexible tubular plastic enclosures together, or folding a single, longer flexible tubular plastic enclosure 304 and joining opposite ends of the enclosure to itself to form a cavity between two main compartments. In such a three-chambered configuration, the flexible tubular plastic enclosure 104 can have additional air valves (which can be as simple as reinforced openings between adjacent compartments) in gaseous communication with each chamber, or with only the main chambers (first chamber 107 and second chamber 109).

FIG. 4 is a sectional side view of another embodiment of a static inflatable photovoltaic collector system 400. The diameter of flexible tubular plastic enclosure 404 is less than the height of the flexible solar photovoltaic collector 402, such that the flexible solar photovoltaic collector 402 takes a parabolic shape within the fully inflated flexible tubular plastic enclosure 104.

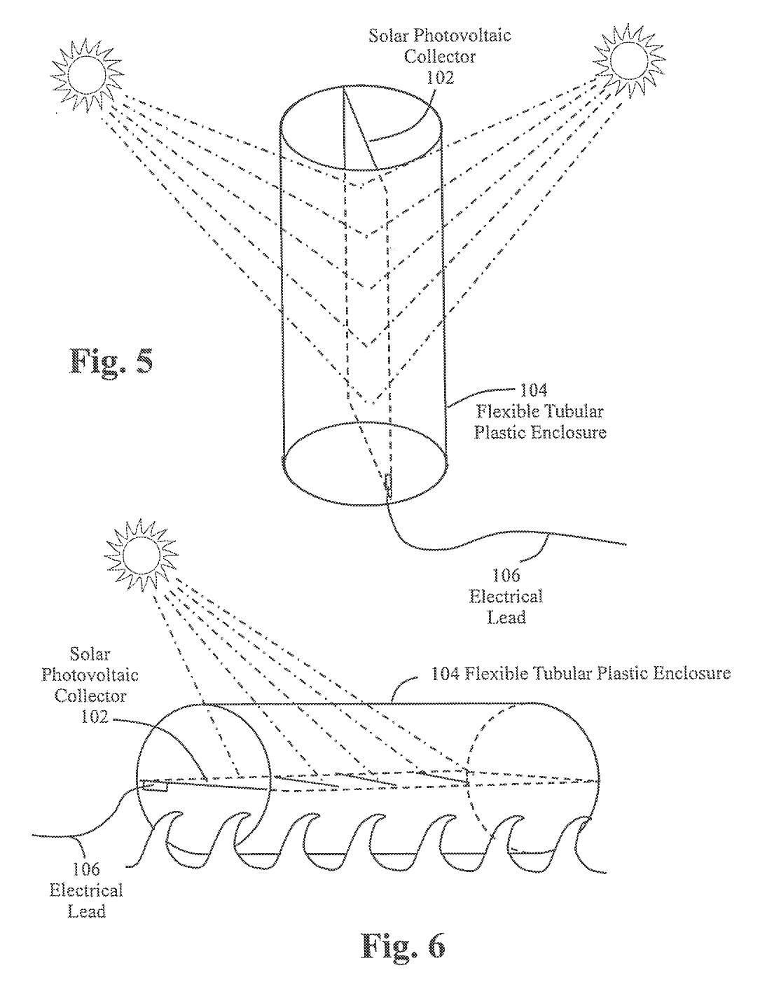

Because of the collector's light weight, it can be erected on any surface, at any angle. FIG. 5 is a perspective view of the embodiment of FIG. 1, described above, where the static inflatable photovoltaic collector system 100 is configured vertically. In such a configuration, the collector can be mounted on, for example, a building wall or on the exterior of a recreational vehicle (RV). In certain embodiments, the vertically mounted solar photovoltaic collector 102 is a double-sided photovoltaic panel, or two single-sided photovoltaic panels mounted back-to-back, to allow photovoltaic electricity generation throughout the day without repositioning the collector.

FIG. 6 is a perspective view of the embodiment of FIG. 1, described above, where the static inflatable photovoltaic collector system 100 is configured horizontally and floated on a body of water. In a particular embodiment, either water can be introduced into the bottom of the assembly, or a weighted solid article can be inserted/affixed inside the flexible tubular plastic enclosure, to both act as a ballast, thereby stabilizing the collector, and the water can potentially provide for cooling of the solar photovoltaic collector 102. The collector can be tethered and used, for example, for recreational marine purposes. The cooling by the water can prevent damage to the solar photovoltaic collector 102. In one embodiment, a flexible collector laying in the bottom of the flexible tubular plastic enclosure would be easily cooled by the water under the floating assembly.

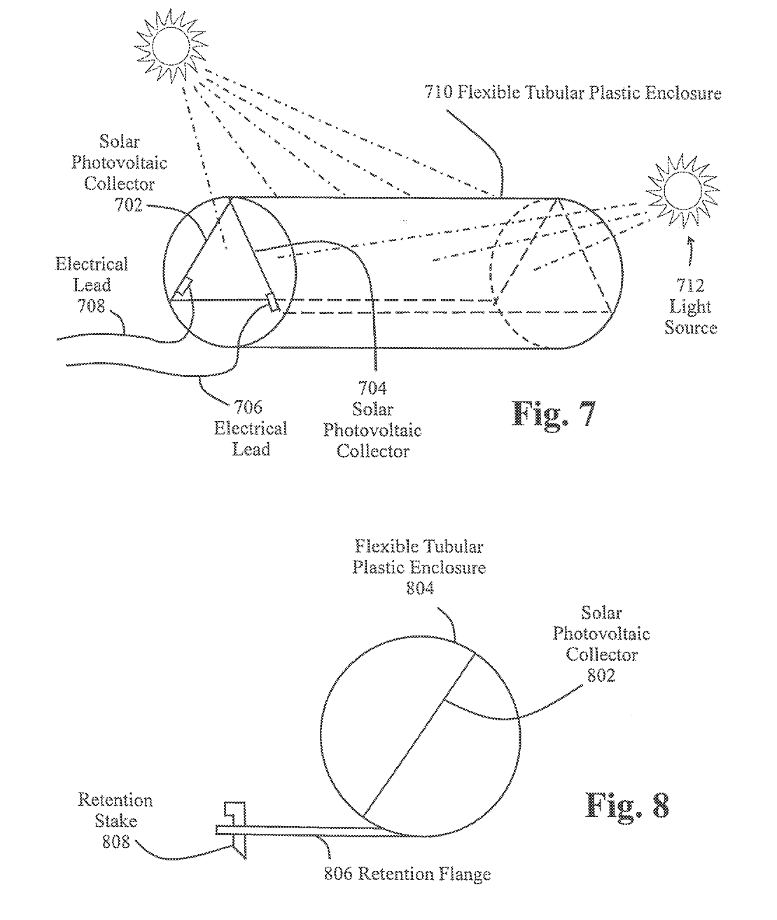

FIG. 7 is a perspective view of an embodiment comprising two solar photovoltaic collectors 702 to maximize photovoltaic energy production. As illustrated in FIG. 7, solar photovoltaic collector 702 and solar photovoltaic collector 704 are both mounted in the flexible tubular plastic enclosure 710. Light source 712 may move to different positions during the day. The two solar photovoltaic collectors 702, 704 are placed in the flexible tubular plastic container 710 and supported by the flexible tubular plastic enclosure 710 so that the solar photovoltaic collectors 702, 704 can collect solar energy from different positions of the light source 712. Electrical leads 706, 708 provide an electrical connection to draw electrical power from the solar photovoltaic collector 704, 702, respectively.

The static inflatable photovoltaic collector system 100 can be easily mounted to a solid surface using, for example, guide lines or bungee cords. Where the collector is floated either on a body of water (FIG. 6) or in air, it can be tethered and/or anchored.

FIG. 8 illustrates a flexible tubular plastic enclosure 804 that is connected to, or formed from, a retention flange 806. Retention flange 806 can be an extension from the flexible tubular plastic enclosure itself, by creating a fold in the envelope and sealing it to itself, or can be another piece of material, including the same type of material forming the flexible tubular plastic enclosure 804, affixed to the flexible tubular plastic enclosure 804. One or more retention stakes 808, 810, 812 are then passed through retention flange 806. The simplicity of the system, including the retention flange 806 allows for the collector to be repositioned as necessary throughout the day to maximize photovoltaic energy production. Electrical lead 814 transmits the electrical power that is obtained from the solar photovoltaic collector 802 for storage or use.

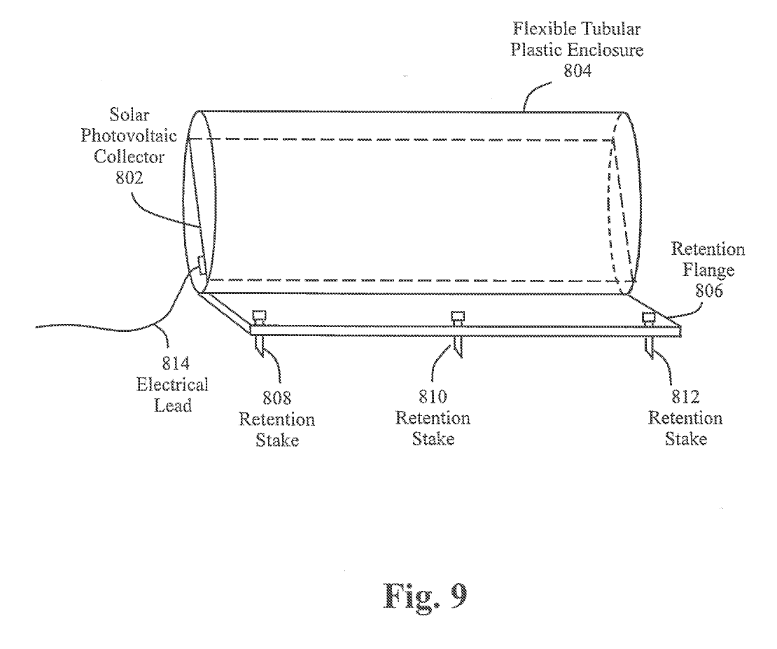

FIG. 9 is a front perspective view of the embodiment of FIG. 8. As illustrated in FIG. 9, the solar photovoltaic collector 802 is disposed in the flexible tubular plastic enclosure 804 so that the solar photovoltaic collector 802 is disposed in a slanted direction, which can be oriented toward the sun. Retention stakes 806, 808, 810 are used to secure the retention flange 806 to the ground. Of course, any type of retention or anchoring device can be used to attach the retention flange 806 to any surface. For example, retention flange 806 may be snapped onto a hard surface, or can be attached with other releasable devices, such as Velcro. In addition, the retention flange 806 can be glued, harnessed or even taped to various surfaces.

In certain embodiments, in addition to providing a way to retain the collector in position, the flange also acts as a “stop,” helping keep the solar photovoltaic collector 102 from sliding within flexible tubular plastic enclosure 104. Generally, with the flange anchored to the ground, the solar photovoltaic collector is heavy enough to lie in the bottom of the flexible tubular plastic enclosure. Alternately, the panel can be glued or otherwise affixed to the interior surface of the flexible tubular plastic enclosure 104.

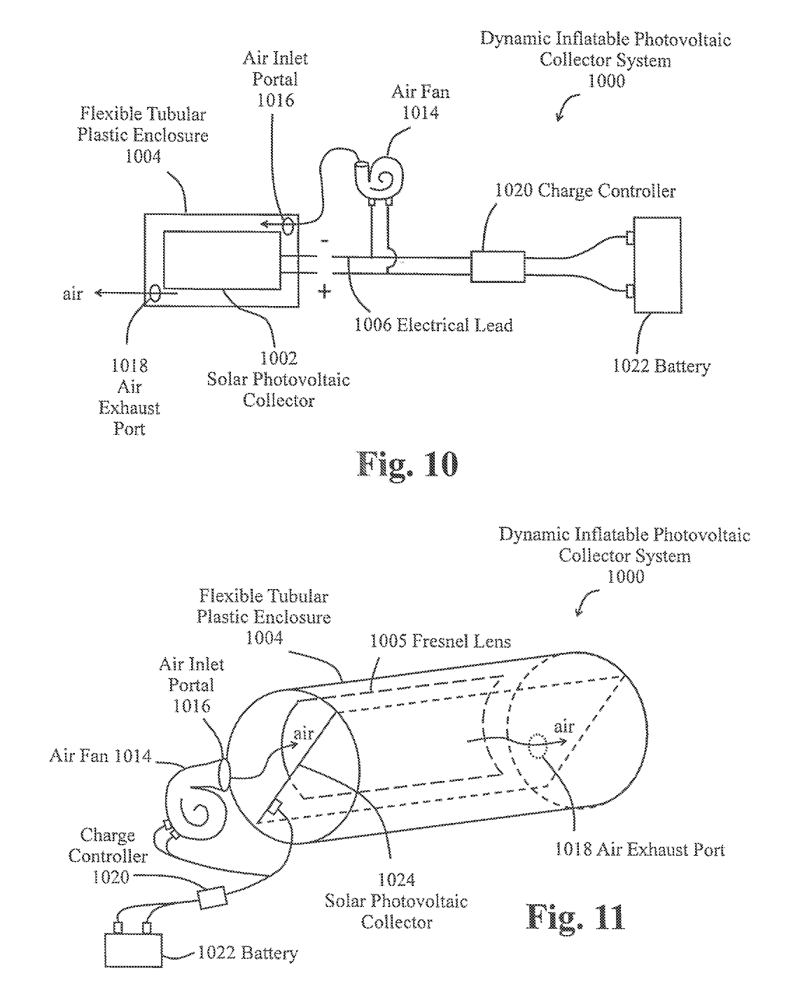

FIG. 10 depicts a schematic of an embodiment of a self-erecting dynamic inflatable photovoltaic collector system 1000. Solar photovoltaic collector 1002 is disposed within flexible tubular plastic enclosure 1004, similarly to static inflatable photovoltaic collector system 1000 described above. In order to collect heat and simultaneously cool the flexible solar photovoltaic collector, a small 12 vDC motor powered air fan 1014 is attached to the flexible tubular plastic enclosure 1004, connected to and powered by either the battery 1022 or the solar photovoltaic collector 1002. The air fan 1014 inflates the flexible tubular plastic enclosure 1004 and also simultaneously provides cooling air flow over the flexible solar photovoltaic collector 1002, and heated air flow from an air exhaust port 1018 out of the flexible tubular plastic enclosure 1004. Electrical lead 1006 directly powers air fan 1014, which forces air into flexible tubular plastic enclosure 1004 via air inlet portal 1016. An appropriate air fan 1014 is selected to provide for sufficient airflow to maintain inflation of the collector and to cool the solar photovoltaic collector 1002. To permit airflow through the flexible tubular plastic enclosure 1004 and to prevent over-inflation, air exits flexible tubular plastic enclosure 1004 via air exhaust port 1018. The exhaust port 1018 is located at an opposite end of the flexible tubular plastic enclosure 1004 from the air fan 1014, so that air flows across the solar photovoltaic collector 1024 and cools the solar photovoltaic collector 1024. The cool air provided by the air fan 1014 prevents damage to the solar photovoltaic collector 1024 and allows the collector to operate at high efficiency at all times, maximizing electrical energy production. Some of the flexible solar photovoltaic collectors are constructed on a plastic substrate that is flexible. However, the plastic substrate may warp when it is overheated. Further, the photovoltaic collectors will be less efficient at high temperatures. Accordingly, the air fan 1014 that causes air to pass over the solar photovoltaic collector 1024 provides cooling to prevent damage while also maximizing the efficiency of the overall system.

Further, the air fan 1014, illustrated in FIG. 11, is connected to the electrical output of the solar photovoltaic collector 1024. If a battery is being charged by the system, the air blower can also be connected directly to the battery. As the dynamic inflatable photovoltaic collector system 1000 is moved, and oriented toward the sun, the speed of the air fan 1014 provides a reliable way of indicating the best orientation of the dynamic inflatable photovoltaic collector system 1000 to collect the most solar energy. In this manner, the dynamic inflatable photovoltaic collector system 1000 can be oriented by the user, and easily reoriented as the sun moves, to provide the greatest output.

FIG. 10 also illustrates the electrical lead 1006 that is connected to charge controller 1020. Electrical lead 1006 is connected to charge controller 1020, which is in turn in electrical communication with battery 1022. In this embodiment, the self-erecting inflatable photovoltaic collector produces sufficient energy to power air fan 1014 and charge battery 1022. In other embodiments, rather than charging a battery, the collector can directly power an electrical load. Solar photovoltaic collector 1002 and materials useful for flexible tubular plastic enclosure 1004 are similar to those described above for use in static inflatable photovoltaic collector system 1000. As with static inflatable photovoltaic collector system 1000, self-erecting inflatable photovoltaic collector system 1000 is easily packable, and is well suited as a portable solar power source for backpacking, camping, RVing, boating and other outdoor activities.

FIG. 11 is a perspective view of self-erecting inflatable photovoltaic collector system 1000 depicted in FIG. 10 and described above, showing the air fan 1014 forcing air into the flexible tubular plastic enclosure 1004 and air exiting via air exhaust port 1018. In addition to maintaining constant inflation of the collector during photovoltaic energy production, the airflow around solar photovoltaic collector 1002 caused by air fan 1014 results in a cooling effect on the photovoltaic panel. This results in increased operational efficiency of the photovoltaic panel. Because air within the flexible tubular plastic enclosure will be warmed relative to ambient air temperatures, heated air exiting flexible tubular plastic enclosure 1004 can be harnessed for heating purposes (e.g., to heat a tent or a greenhouse) or for drying purposes, such as dehydrating fruit, meat, or drying clothing. Heated exhaust can be directed to a desired location by, for example, an interconnecting duct.

Self-erecting inflatable photovoltaic collector system 1000 can be mounted similarly to static inflatable photovoltaic collector system 100, including use of a retention flange, such as retention flange 810, illustrated in FIG. 9. To maximize photovoltaic energy production throughout the day, the collector can be repositioned to where the air fan 1014 runs at maximum speed, indicating maximum energy production.

One or more solar concentrators can also be included in self-erecting inflatable photovoltaic collector system 1000 to focus solar energy on solar photovoltaic collector 1002, maximizing power output. For example, a Fresnel lens 1005, or an array of Fresnel lenses, can be affixed to the flexible tubular plastic enclosure 1004. Alternately, a section of flexible tubular plastic enclosure 1004, or the entire envelope, can be patterned to provide a solar concentrating effect. While one or more solar concentrators can also be used in conjunction with static inflatable photovoltaic collector system 100, the cooling effect provided by the airflow generated in self-erecting inflatable photovoltaic collector system 1000 provides for more efficient power production by solar photovoltaic collector 1002.

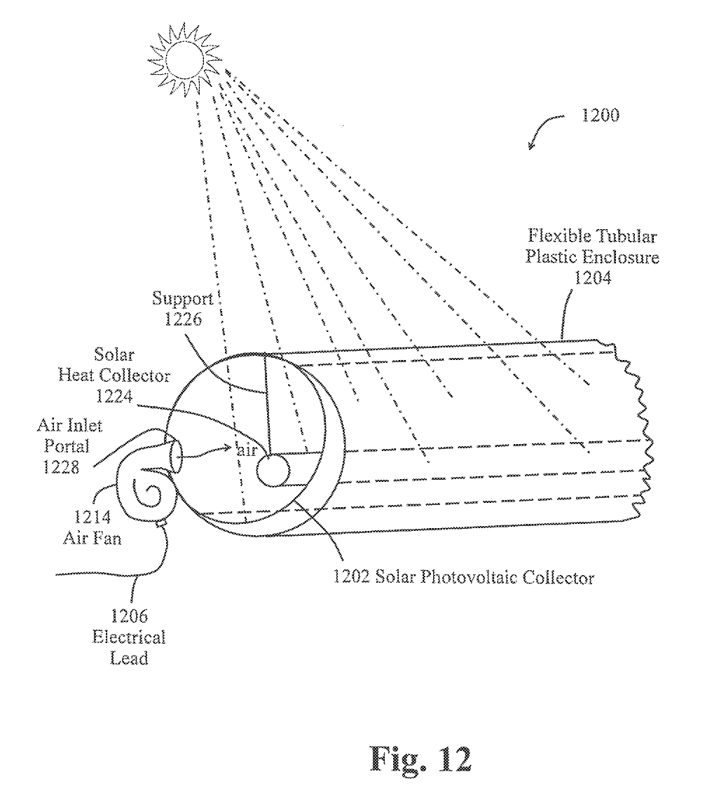

FIG. 12 is a sectional side view partial perspective view of one embodiment of a self-erecting inflatable solar heat and photovoltaic collector 1200. Self-erecting inflatable solar heat and photovoltaic collector 1200 is similar to the self-erecting inflatable photovoltaic collector system 1000 described above, but with the addition of solar heat collector 1224 to further collect solar radiation within flexible tubular plastic enclosure 1204, and increase the thermal energy generated. Solar photovoltaic collector 1202 is disposed within flexible tubular plastic enclosure 1204. Electrical lead 1206 directly powers air fan 1214, which forces air into flexible tubular plastic enclosure 1204 via air inlet portal 1216. An appropriate air fan 1214 is selected to provide for sufficient airflow to maintain inflation of the collector. Solar heat collector 1224 can be a light weight metal tube or rod, painted black to maximize radiation heating. Solar heat collector 1224 is mounted to flexible tubular plastic enclosure 1204 by supports 1226, which extend through flexible tubular plastic enclosure 1204 and are secured, or are affixed to the plastic wall of flexible tubular plastic enclosure. Supports 1226 can be any flexible heat-resistant materials, such as wire.

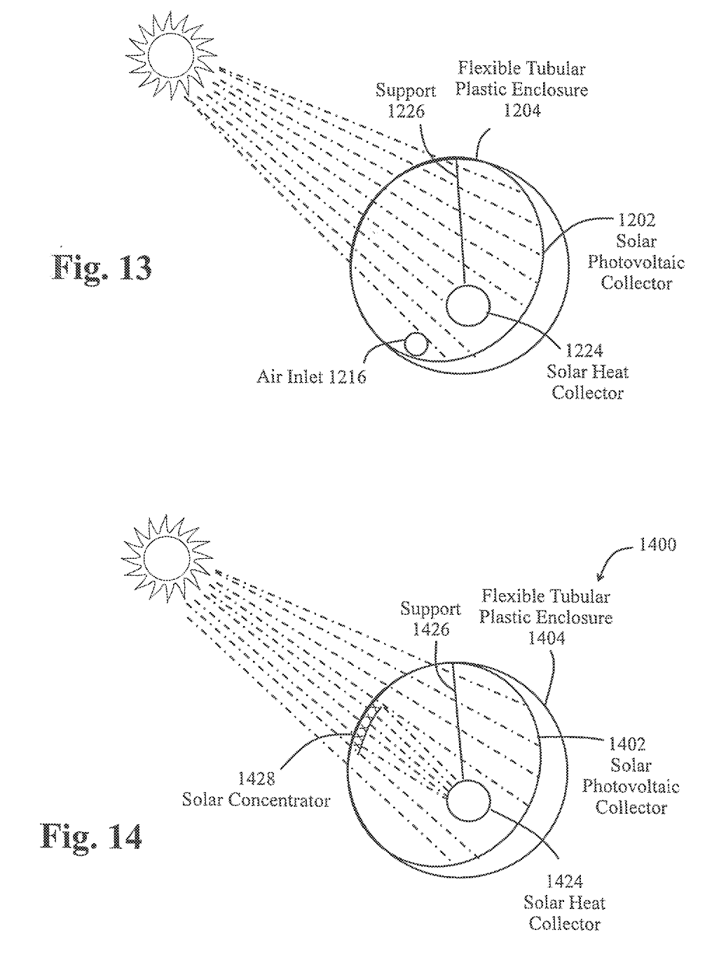

FIG. 13 is a sectional side view of the self-erecting inflatable solar heat and photovoltaic collector 1200 of FIG. 12, described above. To minimize the effect of the shadow of solar heat collector 1224, it is mounted low in front of the solar photovoltaic collector 1202. The position of air inlet 1216 and air exhaust can be selected to optimize airflow, maximizing thermal benefits of the collector. The air flow passes through the heat collector tube to maximize heat transfer to the air with absorbed thermal radiation energy, prior to exiting from the exhaust port.

FIG. 14 is a sectional side view of another embodiment of a self-erecting inflatable solar heat and photovoltaic collector 1400, described above, comprising solar concentrator 1428. As described above, one or more solar concentrators 1428 can be used to focus solar energy on the solar photovoltaic collector 1402, solar heat collector 1424, or both, thereby maximizing the power output, thermal output, or both, respectively. For example, a Fresnel lens, or an array of Fresnel lenses, can be affixed to the flexible tubular plastic enclosure 1404. Alternately, a section of flexible tubular plastic enclosure 1404, or the entire envelope, can be patterned to provide a solar concentrating effect. As shown in FIG. 14, a Fresnel lens has been mounted to flexible tubular plastic enclosure 1404, concentrating solar energy on solar heat collector 1424, thus maximizing the thermal output of the collector. Alternatively, a Fresnel lens, or other solar concentrator, can be embossed, or otherwise formed, into the surface of the flexible tubular plastic enclosure 1404.

In other embodiments, additional photovoltaic cells can be mounted on the solar heat collector 1424 so as to add more electrical energy production capacity than with the solar photovoltaic collector 1402 alone.

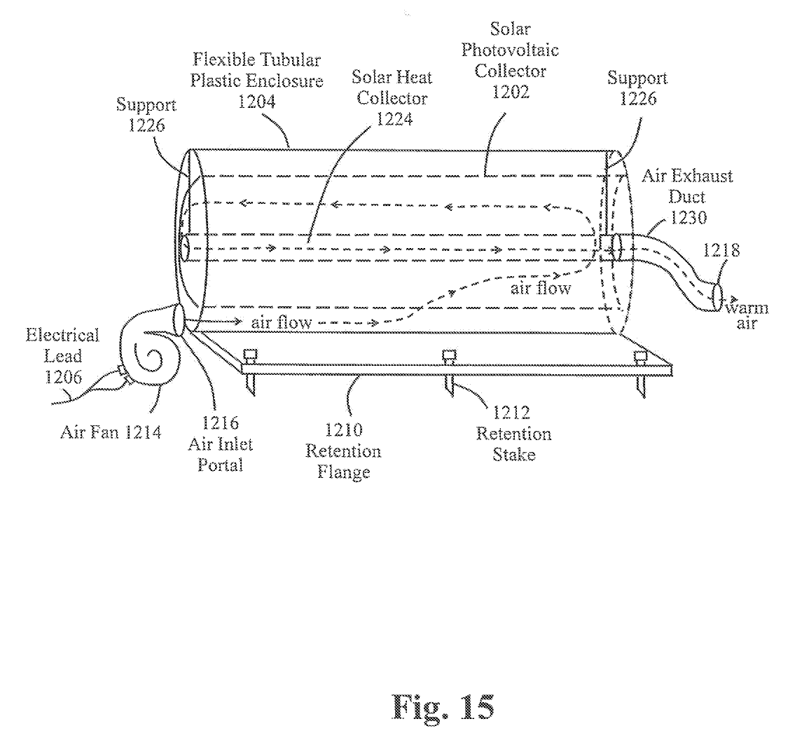

FIG. 15 is perspective view of another embodiment of the self-erecting inflatable solar heat and photovoltaic collector 1200 of FIG. 12, described above. Solar photovoltaic collector 1202 is disposed within flexible tubular plastic enclosure 1204. Electrical lead 1206 directly powers air fan 1214, which forces air into flexible tubular plastic enclosure 1204 via the air inlet portal 1216. Air is heated within the solar heat collector 1224, and exits the flexible tubular plastic enclosure 1204 through air exhaust 1218. Air exhaust duct 1230 is configured to direct heated air exiting the collector tube through air exhaust 1218, which may include a variable orifice to control pressure in the enclosure and air flow. Solar heat collector 1224 is mounted in front of solar photovoltaic collector 1202 by supports 1226, which extend through flexible tubular plastic enclosure 1204 and are secured, or are affixed, to the interior of flexible tubular plastic enclosure 1204. Retention flange 1210 extends towards the front of the collector from its base, and is retained in place by retention stakes 1212.

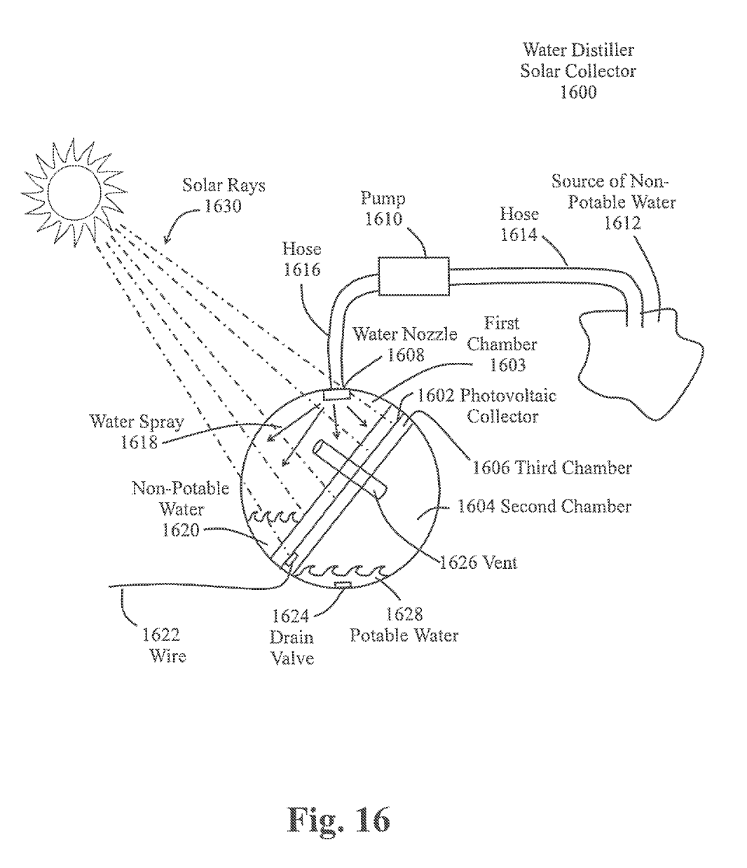

FIG. 16 is a schematic side view of a water distiller solar photovoltaic collector 1600. As illustrated in FIG. 16, a solar photovoltaic collector 1602 is located in a third chamber 1606, which is located between a first chamber 1603 and a second chamber 1604 of the water distiller solar photovoltaic collector 1600. A pump 1610 draws non-potable water from a source of non-potable water 1612 through hose 1614 to hose 1616. Hose 1616 is connected to a water nozzle 1608, which creates a water spray 1618 that is distributed in the first chamber 1603. The spray collects as non-potable water 1620 at the bottom portion of the first chamber 1603. The heat collected in the first chamber 1603 creates water vapor, which passes through vent 1626 to the second chamber 1604. The second chamber 1604 is shadowed from the solar rays 1630 by the photovoltaic collector 1602. Hence, the second chamber 1604 is at a lower temperature than the temperature in the first chamber 1603. When the water vapor from the first chamber 1603 passes through the vent 1626, the water vapor condenses on the surface of the second chamber 1604 and collects at the bottom of the second chamber 1604 as potable water 1628. Drain valve 1624 can then be used to drain the potable water 1628 from the second chamber 1604. The photovoltaic collector 1602 also generates electricity, which is transmitted through wire 1622 for use as desired.

All of the embodiments illustrated in FIG. 1 through FIG. 16 can be manufactured and sold as kits and assembled by the user.

A self-erecting inflatable photovoltaic collector as described herein was constructed using a PowerFilm R-13 solar photovoltaic panel (13 watt, rollable solar panel and charger) disposed within a section of 18″ poly tubing. The R-13 flexible photovoltaic measured 4.5 sq. ft. A 12 vDC fan (Delta Electronics BFB 1021H) was configured to inflate the section of poly tubing. For certain tests, five panels of multi-lens Fresnel lenses were affixed to the section of poly tubing.

Testing of the self-erecting inflatable photovoltaic collector was conducted on Jan. 10, 2016, between 11:00 am and 2:00 pm in Highlands Ranch, Colo. (Table 1). Six test scenarios were examined.

TABLE 1
Self-erecting inflatable photovoltaic collector test results for Jan. 10, 2016.

| | | | | | | Air | | | |
|---|---|---|---|---|---|---|---|---|---|
| | | | | | Ambient | exhaust | Delta | | |
| PV | Poly | Battery | | | temp | temp | temp | Volts | |
| Alignment | Tube | Charger | Blower | Fresnel | (° F.) | (° F.) | (° F.) | DC | Comment |
| Concave | X | | X | | 42 | 55 | 13 | 14.5 | |
| angled | | | | | | | | | |
| Concave | X | | X | | 42 | 57 | 15 | 14.47 | 0.22 |
| angled | | | | | | | | | amps |
| Angled | | X | | | 42 | | | 13.13 | |
| Flat | | X | | | 42 | | | 12.9 | |
| Angled | | X | X | | 42 | | | 12.9 | |
| Flat | X | X | | | 42 | | | 12.9 | |
| Concave | X | X | X | X | 42 | 57 | 15 | 12.9 | |
| optimum | | | | | | | | | |
| Concave | X | X | (deadhead) | | 42 | | | 12.88 | |
| Concave | X | X | X | | 42 | 55 | 13 | 12.62 | |
| Concave | X | X | X | X | 42 | 57 | 15 | 12.55 | |
| Flat | | X | X | | 42 | | | 11.97 | |
| Concave | X | | X | | 42 | | | 11.43 | |
| (flat) | | | | | | | | | |
| Flat | X | | X | | 42 | | | 11.03 | |
| Concave | X | X | X | | | | | 12.9 | 0.70 |
| angled | | | | | | | | | amps |

Compared to the flat and unenclosed photovoltaic panel (no poly tube), electrical power output from the inflated collector showed no degradation in voltage output. The fan selected easily kept the poly tubing inflated, and despite being oversized for the size of the tubing, the collector generated enough power to run the air fan and battery charger simultaneously.

Exhaust air exited the collector at temperatures of about 15° F. above the intake (ambient) temperature, demonstrating the ability to use the collector not only as a power source, but also as a solar heat generator.

A self-erecting inflatable photovoltaic collector as described herein was constructed using a PowerFilm R-13 solar photovoltaic panel (13 watt, rollable solar panel charger) disposed within a section of 14″ poly tubing. The R-13 flexible photovoltaic measured 4.5 sq. ft. When inflated, the section of poly tubing had a volume of approximately 4 cu. ft. A DC fan (Delta Electronics BFB 1021H) was configured to inflate the section of poly tubing. For one test, panels of multi-lens Fresnel lenses were affixed to the section of poly tubing.

Testing of the self-erecting inflatable photovoltaic collector was conducted on Feb. 13, 2016, between 12:00 pm and 2:25 pm in Highlands Ranch, Colo. (Table 2). The collector was turned to face the sun at 1:20 pm and at 2:00 pm. The collector was initially run for 10 minutes prior to testing, and then for 20 more minutes following an initial reading to reach steady state.

TABLE 2
Self-erecting inflatable photovoltaic collector test results for Feb. 13, 2016.

| | | Air | | | Voltage | Amps | | |
|---|---|---|---|---|---|---|---|---|
| | Ambient | exhaust | Voltage | Amps | (Blower | (Blower | Air | |
| | temp | temp | (Blower | (Blower | and | and | Velocity | |
| Time | (° F.) | (° F.) | Only) | Only) | Charger | Charger) | (ft/min) | Fresnel |
| 12:00 | 72 | 98.5 | 15.02 | | | | 1251 | |
| 12:20 | 75 | 102.3 | 15.4 | | | | 1366 | |
| 12:45 | 78 | | 15.44 | | 12.47 | | | |
| 1:30 | 77 | 87.5 | 15.42 | | | | 1045 | X |
| 1:40 | 77 | 93.7 | 15.41 | 0.25 | 12.43 | 0.19 | 1054 | |
| | | 83.7 | 14.9 | | | | 1175 | |
| 2:05 | 76 | 85.1 | 15.3 | | 12.43 | | 1223 | |
| 2:10 | 75 | 79.5 | 15.1 | | 12.42 | | | |
| 2:20 | 75 | 82.5 | 14.18 | | | | 1095 | |
| 2:25 | 75 | 82.8 | | | | | 822 | |

The February tests confirmed the results of the January tests. Again, compared to the flat and unenclosed photovoltaic panel (no poly tube), electrical power output from the inflated collector showed no degradation in voltage output.

Three fan sizes were tested (0.57 amps, 0.36 amps, and 0.15 amps), with the larger and mid-sized fans shown to be sufficient to inflate the 4 cubic foot test unit. Again, exhaust air was warmed by about 15° F. above ambient air temperatures, and about 30° F. when the heat collector was included.

While the invention has been described with reference to various and preferred embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof.

Therefore, it is intended that the invention not be limited to the particular embodiments disclosed herein contemplated for carrying out this invention, but that the invention will include all embodiments falling within the scope of the claims.

What is claimed is:

1. A method of generating electrical power and warm air from the sun comprising:
placing a flexible solar photovoltaic collector in a flexible tubular plastic enclosure so that said flexible solar photovoltaic collector is supported by said flexible tubular plastic enclosure;
inflating said flexible tubular plastic enclosure so that said flexible solar photovoltaic collector is supported by said flexible tubular plastic enclosure;
moving said flexible tubular plastic enclosure so that said flexible solar photovoltaic collector is directed at said sun;
collecting electrical energy obtained by said flexible solar photovoltaic collector with a pair of wires;
coupling said wires to a battery;
storing said electrical energy in a battery.

2. The method of claim 1 further comprising:
connecting a motor driven blower to said wires to create a source of blowing air;
connecting said source of blowing air to said flexible tubular plastic enclosure so that said source of blowing air passes over said flexible solar photovoltaic collector and cools said flexible solar photovoltaic collector;
collecting warm air from an air exhaust port in said flexible tubular plastic enclosure;
using said warm air for heating and drying purposes.

3. The method of claim 2 further comprising:
providing a retention flange on said flexible tubular plastic enclosure.

4. The method of claim 3 further comprising:
using stakes to anchor said retention flange and said flexible tubular plastic enclosure.

5. The method of claim 4 further comprising:
selecting a flexible solar photovoltaic collector that has at least one dimension that substantially matches a diameter dimension of said flexible tubular plastic enclosure.

6. The method of claim 1 further comprising:
forming three chambers in said flexible plastic enclosure;
placing said flexible solar photovoltaic collector in a center chamber of said three chambers.

7. The method of claim 1 further comprising:
spraying non-potable water into a first chamber of said three chambers;
passing vaporized water through a vent from said first chamber to a third chamber of said three chambers;
condensing said water vapor in said third chamber to provide a source of potable water.

8. The method of claim 6 further comprising:
placing a solar heat collector in said flexible tubular plastic enclosure;
concentrating solar energy on said solar heat collector using a solar concentrator attached to said flexible tubular plastic enclosure.

9. The method of claim 1 further comprising:
placing a gas in said flexible tubular plastic enclosure that is lighter than air so that said flexible tubular plastic enclosure floats in air.

10. The method of claim 1 further comprising:
sealing said flexible tubular plastic enclosure so that said flexible tubular plastic enclosure is able to float on water.
utilizing a flexible solar photovoltaic collector in said flexible plastic enclosure, such that it conforms to the shape, lies in the bottom and receives cooling from the water underneath the enclosure.

11. A solar energy system comprising:
a flexible solar photovoltaic collector having a predetermined height and a predetermined length;
a flexible tubular plastic enclosure surrounding said flexible solar photovoltaic collector, said flexible tubular plastic enclosure having a diameter that substantially matches said height of said flexible tubular plastic enclosure and a length that is greater than said predetermined length of said flexible solar photovoltaic collector, said flexible tubular plastic enclosure inflated so that said flexible solar photovoltaic collector is supported in said flexible tubular plastic enclosure and said flexible tubular plastic enclosure and said flexible solar photovoltaic collector can be oriented towards sunlight by moving said flexible tubular plastic enclosure;
wires connected to said flexible solar photovoltaic collector for collecting electrical energy from said flexible solar photovoltaic collector;
a battery connected to said wires for storing said electric energy.

12. The solar energy system of claim 11 further comprising:
a blower coupled to said wires that generates a source of blowing air, said blower connected to said flexible tubular plastic enclosure to inflate said flexible tubular plastic enclosure and cool said flexible solar photovoltaic collector;
a port disposed in said flexible tubular plastic enclosure that provides a supply of warm air from said flexible tubular plastic enclosure.

13. The solar energy system of claim 12 further comprising:
a retention flange connected to said flexible tubular plastic enclosure that is adapted to secure said flexible tubular plastic enclosure.

14. The solar energy system of claim 11 wherein said flexible tubular plastic enclosure has three chambers and said flexible solar photovoltaic collector is disposed in a central chamber.

15. The solar energy system of claim 14 further comprising:
a spray nozzle located in a first chamber of said three chambers that sprays non-potable water in said first chamber;
a vent that passes water vapor from said first chamber to a third chamber;
a port located in said third chamber that provides an access to potable water condensed in said third chamber.

16. The solar energy system of claim 11 further comprising:
a solar heat collector disposed in said flexible tubular plastic enclosure;
a solar concentrator disposed on said flexible tubular plastic enclosure that concentrates solar rays on said solar heat collector.

17. The solar energy system of claim 11 further comprising:
a lighter than air gas disposed in said flexible tubular plastic enclosure that will float in air.
